(19) United States
(12) Patent Application Publication
(10) Pub. No.: US 2024/0385944 A1
(43) Pub. Date: Nov. 21, 2024

(54) CONCURRENCY-ENABLED LOOP CONSTRUCTS USING STATE VARIABLE MUTATION PRINCIPLE

(71) Applicant: Zoho Corporation Private Limited, Chengalpattu Taluk (IN)

(72) Inventors: Sridhar Vembu, Tenkasi (IN); Akshhayaa S, Chengalpattu Taluk (IN)

(21) Appl. No.: 18/667,964

(22) Filed: May 17, 2024

Related U.S. Application Data
(60) Provisional application No. 63/526,545, filed on Jul. 13, 2023.

(30) Foreign Application Priority Data
May 19, 2023 (IN) 202341035204
May 7, 2024 (IN) 202441036178

(51) Int. Cl. G06F 11/36; G06F 11/07

(52) U.S. Cl. CPC G06F 11/3612; G06F 11/0772

(57) ABSTRACT

Concurrency within a loop construct is enabled by introducing state variables and State Variable Mutation principles on these state variables in the loop construct. The loop construct is associated with variable(s) called State(s) or State variable(s). These state variables are the ones that are mutated within an associated loop construct. Access to these states outside this loop construct is not permitted. State Variable Mutation Principles are the set of rules defined for mutating these state variables. These rules are in place to aid optimization, such as concurrent execution of state modifications within the loop construct. Rules are handled by a Loop Concurrency Validator introduced in a compilation process. Rules imposed on the state variables along with the delayed write followed within the loop construct enables instructions within the loop construct to be executed in parallel.

### CROSS-REFERENCE TO RELATED APPLICATIONS

This application claims priority to Indian Provisional Patent Application No. 20/234,1035204 filed May 19, 2023, Indian Provisional Patent Application No. 20/244,1036178 filed May 7, 2024, and U.S. Provisional Patent Application Ser. No. 63/526,545 filed Jul. 13, 2023, each of which is incorporated herein by reference.

### BACKGROUND

A programming language comprises constructs like data types, condition check constructs, loop constructs, and functions. When data types take care of declaring the variables appropriately, condition check and loop constructs help in implementing the logical functionality for the tasks, and functions provide flexibility for programmers to divide a problem into smaller tasks to facilitate reusability. The compiler syntactically and semantically verifies the correctness of the programming language constructs and, in response to detected errors, generates messages about the errors.

### BRIEF DESCRIPTION OF DRAWINGS

FIGS. 1A and 1B are a diagram of examples of phase flow through compiler engines with a Loop Concurrency Validator and associated components.

FIG. 2 is a flowchart illustrating an example of Unused State Validation. FIG. 3 is a flowchart illustrating an example of Validating State Not Mutated More

Than Once in an Iteration (Singleton and Collection Set States).

FIG. 4 is a flowchart illustrating an example of Validating State Not Mutated More Than Once in an Iteration (Collection Sequence States).

FIG. 5 is a flowchart illustrating an example of Validation of State Variable Mutation (SVM) Principle in Nested Loops.

FIG. 6 is a flowchart illustrating an example of Singleton and Collection State Mutation Validation in a Single Condition Check Construct within a Loop.

FIG. 7 is a flowchart illustrating an example of Singleton and Collection States Mutation in Multiple Condition Check Constructs within a Loop.

FIG. 8 is a flowchart illustrating an example of Collection Sequence State Append Operation Validation.

FIG. 9 is a flowchart illustrating an example of Collection Sequence State Remove Operation Validation.

### DETAILED DESCRIPTION

A function is a programming language construct that performs operations using mutable internal states. In a specific implementation, a function has blocks like parameter, state, for_each, and return. A loop construct within such a function has states/state variables defined with it, and the loop construct returns values through the states/state variables. State Variable Mutation (SVM) Principles define rules for modifying the states/state variables. A “state” refers to state variables that are associated with a loop construct such as a for_each block. States are “:=” definitions private to the loop construct block.

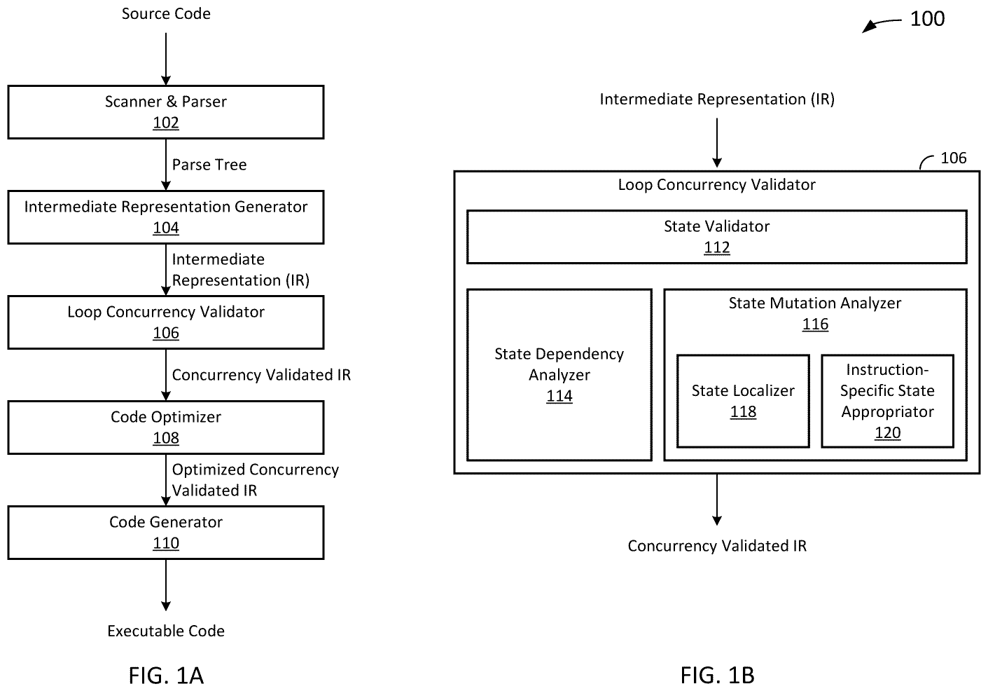

FIGS. 1A and 1B are a diagram 100 of examples of phase flow through compiler engines with a Loop Concurrency Validator and associated components. The diagram 100 includes a Scanner & Parser Engine 102, an Intermediate Representation (IR) Generator Engine 104, a Loop Concurrency Validator Engine 106, a Code Optimizer Engine 108, and a Code Generator Engine 110. The diagram 100 illustrates inputs to the engines: Source Code to the Scanner & Parser Engine 102, Parse Tree to the IR Generator Engine 104, IR to the Loop Concurrency Validator Engine 106, Concurrency Validated IR to the Code Optimizer Engine 108, and Optimized Concurrency Validated IR to the Code Generator Engine 110.

In the example of FIG. 1A, the Parse Tree is represented distinctly from the IR, but it should be noted a parse tree can itself be an IR. In an implementation in which the Parse Tree is an IR, the IR Generator Engine 104, as depicted in the diagram 100 with a Parse Tree input and IR output, may or may not be optional. In a specific implementation, the IR is also a parse tree; in a first alternative, the IR is a graph; in a second alternative, the IR is a hybrid of a tree and a graph; and in a third alternative, the IR is some other applicable data structure. Also, the Parse Tree (or “parse structure”) can be implemented as a graph, hybrid of a tree and graph, or some other applicable data structure.

The diagram 100 illustrates outputs from the engines: The Parse Tree from the Scanner & Parser Engine 102, the IR from the IR Generator Engine 104, the Concurrency Validated IR from the Loop Concurrency Validator Engine 106, the Optimized Concurrency Validated IR from the Code Optimizer Engine 108, and Executable Code from the Code Generator Engine 110.

The system described in association with FIGS. 1A and 1B, and other descriptions in this paper, makes use of a computer-readable medium (CRM) to couple components of the system, as do all known computer systems. The CRM and other computer readable mediums discussed in this paper are intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few).

The CRM and other computer readable mediums discussed in this paper are intended to represent a variety of potentially applicable technologies. For example, the CRM can be used to form a network or part of a network. Where two components are co-located on a device, the CRM can include a bus or other data conduit or plane. Where a first component is co-located on one device and a second component is located on a different device, the CRM can include a wireless or wired back-end network or LAN. The CRM can also encompass a relevant portion of a WAN or other network, if applicable.

The devices, systems, and computer-readable mediums described in this paper can be implemented as a computer system or parts of a computer system or a plurality of computer systems. As used in this paper, a server is a device or a collection of devices. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. Depending upon implementation-specific or other considerations, the I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, ISDN modem, cable modem, token ring interface, satellite transmission interface (e.g., “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to end user devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their end user device.

A computer system can be implemented as an engine, as part of an engine or through multiple engines. As used in this paper, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors or a first engine and a second engine can share one or more processors with one another or other engines. Depending upon implementation-specific or other considerations, an engine can be centralized or its functionality distributed. An engine can include hardware, firmware, or software embodied in a computer-readable medium for execution by the processor that is a component of the engine. The processor transforms data into new data using implemented data structures and methods, such as is described with reference to the figures in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

A database management system (DBMS) can be used to manage a datastore. In such a case, the DBMS may be thought of as part of the datastore, as part of a server, and/or as a separate system. A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Alpha Five, DataEase, Oracle database, IBM DB2, Adaptive Server Enterprise, FileMaker, Firebird, Ingres, Informix, Mark Logic, Microsoft Access, InterSystems Cache, Microsoft SQL Server, Microsoft Visual FoxPro, MonetDB, MySQL, PostgreSQL, Progress, SQLite, Teradata, CSQL, OpenLink Virtuoso, Daffodil DB, and OpenOffice.org Base, to name several.

Database servers can store databases, as well as the DBMS and related engines. Any of the repositories described in this paper could presumably be implemented as database servers. It should be noted that there are two logical views of data in a database, the logical (external) view and the physical (internal) view. In this paper, the logical view is generally assumed to be data found in a report, while the physical view is the data stored in a physical storage medium and available to a specifically programmed processor. With most DBMS implementations, there is one physical view and an almost unlimited number of logical views for the same data.

A DBMS typically includes a modeling language, data structure, database query language, and transaction mechanism. The modeling language is used to define the schema of each database in the DBMS, according to the database model, which may include a hierarchical model, network model, relational model, object model, or some other applicable known or convenient organization. An optimal structure may vary depending upon application requirements (e.g., speed, reliability, maintainability, scalability, and cost). One of the more common models in use today is the ad hoc model embedded in SQL. Data structures can include fields, records, files, objects, and any other applicable known or convenient structures for storing data. A database query language can enable users to query databases and can include report writers and security mechanisms to prevent unauthorized access. A database transaction mechanism ideally ensures data integrity, even during concurrent user accesses, with fault tolerance. DBMSs can also include a metadata repository; metadata is data that describes other data.

As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

Referring once again to the example of FIG. 1A, the Loop Concurrency Validator Engine 106, which is part of a compilation process, receives the IR, validates an SVM principle, and generates the Concurrency Validated IR. As depicted in FIG. 1B, the Loop Concurrency Validator Engine 106 includes a State Validator Subengine 112, a State Dependency Analyzer Engine 114, and a State Mutation Analyzer Subengine 116; the State Mutation Analyzer includes two components, namely the State Localizer 118 and the Instruction Specific State Appropriator 120.

The State Validator Subengine 112 validates that the state variables (e.g., Singleton state variables, Collection Set state variables, and Collection Sequence state variables) defined with a loop construct are used within the loop construct. The State Dependency Analyzer Subengine 114 identifies the state variables and associates them with their corresponding loop constructs.

The State Mutation Analyzer Subengine 116 validates the state variables using the State Localizer 118 and the Instruction Specific State Appropriator 120. In a specific implementation, the State Mutation Analyzer Subengine 116 validates that the Singleton and Collection set state variables are not mutated more than once within the loop construct, and the same index location of the Collection Sequence state variable is not mutated more than once within the loop construct. The State Localizer 118 maps the state variables to their specific scopes within the loop construct. The Instruction Specific State Appropriator 120 verifies that within the scope assigned to each of the state variables by the State Localizer, a state variable is not accessed in more than one mutation instruction (thereby appropriating the state variable), and an access of the same state by one other mutation instruction in the same scope throws an error. Once these verifications and validations are performed, the loop construct in the compiler can be referred to as a Concurrency Enabled Loop Construct data structure.

In a specific implementation, access to the state variables outside the loop construct is not permitted. This may be carried out by semantic validation during compilation. The compiler reports an error, if there is any attempt to modify them outside the loop construct say, the for_each block, with an error message indicating “State variables are not to be modified outside the for_each loop construct”. SVM Principles are the set of rules defined for mutating the state variables within the loop construct. The rules imposed on the state variables along with the delayed write process within the loop construct enables the instructions within the loop construct to be executed in parallel.

The states in a loop construct are either singleton data or a collection, where collection is a set or a sequence. A set is an ordered collection of entities without duplicates, and a collection is an ordered collection of entities that may contain duplicates, and each entity in the collection is identified by an index value. The starting index value for a collection set is taken as 1 throughout this document. These states are associated with a loop construct such as for_each block or while loop and are mutated within the loop construct and not anywhere else. The loop construct can communicate to the outer scope through the states/state variables associated with the loop construct. SVM Principles are the set of rules defined for mutating these state variables. The rules imposed on the state variables along with the delayed write process within the loop construct enables the instructions within the loop construct to be executed in parallel. The execution time of the loop construct may be lesser in concurrent execution under certain scenarios than the same set of instructions getting executed in sequence.

Permitting the function parameters to be mutated within a function will lead to the value of the parameters becoming un-trackable or will lead to untoward changes leading to undesirable outcomes. In such scenarios, it may be desirable to keep the function parameters immutable within the function, and in such cases, using the concurrency-enabled loop construct with state variables within the functions allows this. The state variables associated with the loop constructs are mutated within the loop construct and not anywhere else, and also no other variables defined outside the loop construct are mutated within it. This verification may be carried out by semantic validation. If this concurrency-enabled loop construct with state variables is used within a function, then it provides a benefit of supporting the immutability of the function parameters.

To facilitate concurrency within the loop construct, the following features are incorporated. 1) Constraints on the loop construct to ensure provable halting. 2) Loop constructs follow delayed write. 3) Validation of SVM Principles (including, e.g., State Validation Rules and State Mutation Rules).

In a specific implementation, in addition to the validations of the states and state mutations, additional constraints are enforced on the loop construct to avoid infinite looping. For example, two different constraints are imposed on the loop construct to ensure the termination of the loop. These constraints are 1) the collection on which the loop construct operates is to be of finite size and 2) no modifications are permitted to the iteration variable or the parameters of the function. These constraints are explained with the code snippet in Example 1.

```
Sum:= Function
  parameter
    Input[ ]: number[ ]
  state
    PartialSum:= Number(init: 0)
  for_each(I, in: 1..input[ ].count)
      update(partial_sum, partial_sum + input[i])
  return
    partial_sum
```

### Example 1. Code Snippet for Illustrating Constraints on a Loop Construct (for_each loop)

In the above code snippet Example 1, Line 1 defines Sum as a Function having input parameter (line 2) “Input[ ],” which is a sequence of numbers (line 3) that returns (line 8) a value “partial_sum,” which is a number (line 9). A “for_each” loop construct is defined in line 6 where, ‘I’ is the variable that iterates on the input[ ] sequence for Input[ ].count number of times. A state variable of the for_each loop, PartialSum which is a number is declared and initialized to 0 in lines 4 and 5. Line 7 within the loop construct calculates the sum of elements in the input[ ] sequence by updating the value of the state variable “partial_sum” of the for_loop in each of the iterations. The final value is returned through the return statement in lines 8 & 9. For the loop construct to operate without getting into an infinite loop, the collection sequence input[ ] on which the loop construct operates is to be a finite set, so that the input[ ].count returns a finite number. The iterator variable ‘I’ that iterated the loop for input[ ].count number of times is not updated inside the loop construct between lines 6 and 8 so as to ensure the iterator variable ‘I’ is not modified unexpectedly to get stuck into an infinite loop. An iteration variable cannot be modified in statements included within the for_each block. If there is an attempt to modify an iteration variable inside the for_each block, the compiler reports an error, with an error message such as “An iteration variable cannot be modified within a for_each iteration.”

It is to be noted that loop constructs of a programming language e.g. for ( ) and while ( ) loop constructs, may be extended/enhanced with the proposed concurrency-enabled loop construct. For example, extension to a typical “for loop” in a programming language to use the state variables and SVM Principles as described herein is possible.

In a specific implementation, loop constructs follow delayed write. Instructions in the same indentations of a loop construct are executed in parallel to exhibit loop concurrency. Read operations are performed as soon as each of the iterations starts, but the write operations are delayed and performed on completion of an iteration.

In a specific implementation, SVM Principles include Singleton State/State Variable and Principles and Collection State/State Variable Principles. An overview of the different types of states is described below before proceeding to the description of the validation rules on them.

Singleton State/State Variable is similar to a variable like integer, float, character, etc. in other programming languages. It is considered a unit of data. The entire state variable is affected during its creation, update, and deletion.

Collection State/State Variable is a group of individual variables forming a collection and identified by a single name. A collection is a Set or a Sequence. Behavioral differences in collection set and collection sequence state variables demand different methodologies for validation, which are explained below.

As used in this paper, a Collection Set is a set of variables without any duplication. They do not have any index values to access the elements of the Collection Set. When the Collection Set is created, the entire set of elements of the set are allocated memory and are treated as a single unit. In a specific implementation, when an update operation is carried out on a Collection Set, the syntax used is update (state_set{ }, new_set{ }), where state_set{ } is the Set variable used and during its update, the entire set is removed and the new_set{ } is created. Removing an element from the Collection Set also occurs the same way.

As used in this paper, a Collection Sequence has index values to access its elements and hence can accommodate duplicate values that are distinguished by their index locations. In a specific implementation, with Update (state_sequence[ ], new_sequence[ ]), where state_sequence[ ] is the Set variable used and during its update, the entire set is removed and the new_sequence is created. Update can also happen to an indexed element in the Collection Sequence. Removing an element or an index location is also permitted.

In an example of operation, two different types of mutation are performed, where the first type deals with a change in the value of the state variables and the second one is the change in size of the state variable.

The Change in Value mutation is performed on both the singleton state variable and the collection state variables (sets & sequences). In a singleton variable and collection sets, the variable's value is completely changed. However, in a collection sequence variable, a change to a single element in the sequence is also considered to be a mutation to the specific index location of the collection state variable. The operation that performs this is an “Update” operation.

The Change in Size mutation is performed on Collection sequence and Collection set state variables. If the number of elements in the collection increases or decreases, then it is a change in size mutation. The operations that perform this are “Update”, “Remove”, and “Append”.

SVM principles are the set of rules defined for the states of a concurrency-enabled loop construct, which form the basis for implementing concurrency within a loop construct. The Loop Concurrency Validator in the compiler handles the validations to guarantee the application of these rules. There are two validation rules, “State Validation” and “State Mutation Validation,” emphasized by this principle. These set of rules defines the way the states associated with the loop construct are used and mutated to retain the advantage of concurrency offered within the loop construct. Two rules are defined for the Singleton and Collection States (Sets and Sequences) variables. They are detailed in the subsections.

The State Validation Rule is common to both types of variables, and can be conceptually described as, “The total number of states defined in a loop construct is equal to the total number of unique states mutated within the loop construct.” This ensures that states in a loop construct are mutated within the loop construct. This rule is common to both the Singleton states and the Collection States. However, the second rule is different for the states.

The State Mutation Validation (e.g., for the Singleton and Collection Set states) Rule can be conceptually described as, “Singleton and Collection Set states cannot be mutated more than once within a loop construct”, and the second rule for the Collection Sequence state can be conceptually described as, “Collection Sequence state are mutated more than once in a loop construct, however, mutation to the same index location is not permitted.”

A loop construct can become a Concurrency-Enabled Loop Construct if the above features are facilitated through semantic validation, where, the collection on which the loop iterates is of finite size and/or the iterator is updated in such a way that the loop terminates after a finite number of iterations, reading happens immediately when an iteration starts but write operations are carried out at the end of the execution of the loop construct, each of the loop constructs is associated with one or more state variables and the State Validation Principles are followed in the loop construct.

The description herein for support in a compiler for “Loop Concurrency Validation” is provided illustratively. It will be appreciated that the compiler support for “Loop Concurrency Validation” may be implemented in similar ways over various phases and passes of compilation, using the principles described herein.

As mentioned in the State Variable Mutation Principle, two validations are performed on the states defined with the loop construct: State Validation and State Mutation Validation. In a specific implementation, State Validation requires “The total number of states defined in a loop construct is equal to the total number of unique states mutated within the loop construct.” The compiler checks if the state variables defined in the loop construct are used/mutated within the loop construct. This validation ensures that NO STATE REMAINS UNUSED. This may be carried out by semantic validation.

In another implementation, State Validation is performed by verifying that each of the defined state variables is mutated at least once within the loop construct. The compiler checks if the state variables defined in the loop construct are used/mutated within the loop construct. This validation ensures that NO STATE REMAINS UNUSED. This may be carried out by semantic validation.

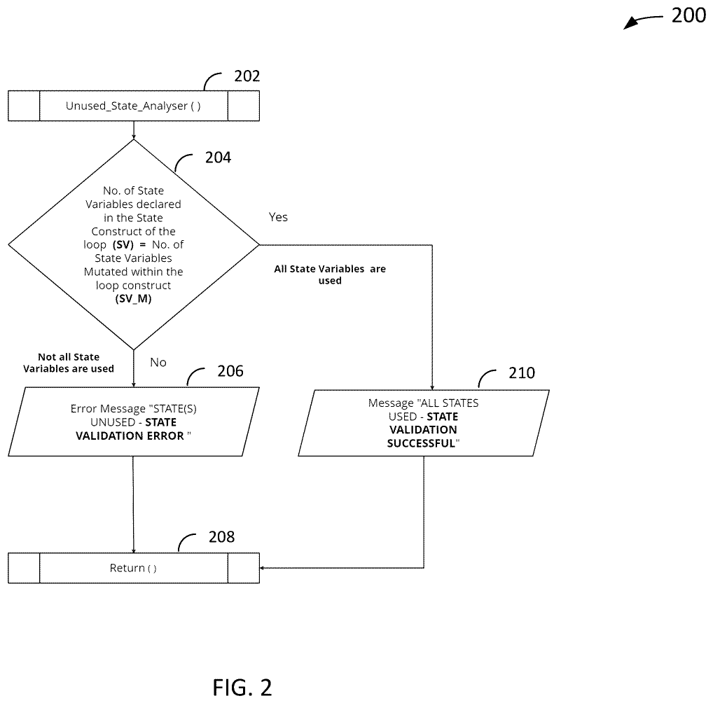

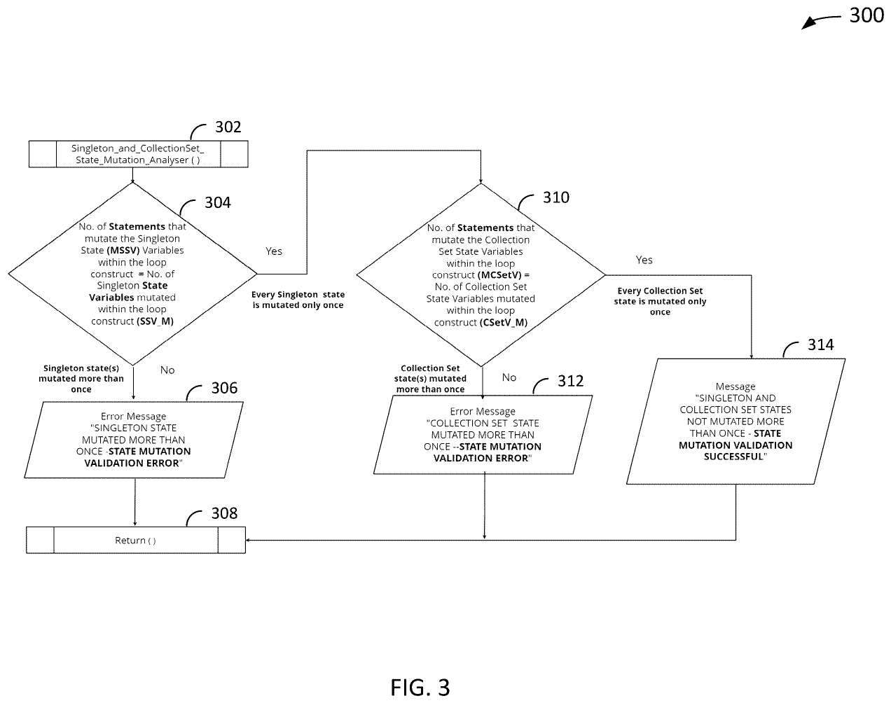

FIG. 2 depicts a flowchart 200 illustrating an example of Unused State Validation. The flowchart 200 starts at Unused_State_Analyzer ( ) 202 and continues to decision point 204 where it is determined whether the number of State Variables declared in the State Construct of the Loop (SV) is equal to the number of State Variables Mutated within the Loop Construct (SV_M). If not (204-No), then the flowchart 200 continues to module 206 where an error occurs, which can be characterized as generating an error message “States Unused—State Validation Error” because not all State Variables are used; then the flowchart 200 ends at Return ( ) 208. If, on the other hand, SV=SV_M (204-Yes), then the flowchart 200 continues to module 210 where an error does not occur, which can be characterized as generating a message “All States Used—State Validation Successful” because all State Variables are used; then the flowchart 200 ends at Return ( ) 208.

Consider the code snippet in Example 2. Here, the validation of the first rule of the SVM Principle applied to check if the states defined with a loop construct is mutated within the loop construct.

```
  1 StateConcurrency1:= Function
  2 parameter
  3 Input[ ]: number[ ]
  4 state
  5 PartialSum:= Number(init: 0)
  6 PartialProd:= Number(init:1)
  7 for_each(I, in: 1..input[ ].count)
  8 update(partial_sum, partial_sum + input[i])
  9 update(partial_prod, partial_prod * input[i])
10
11 return
12 (partial_sum, partial_prod)
```

### Example 2. Sample (Valid) Code Snippet for Concurrently Updating Multiple States Within a Loop Construct

In the sample code snippet of Example 2, a function named “StateConcurrency1” is defined with its parameter block accepting the input sequence Input[ ] as seen in lines 2 and 3. The state block that begins at line 4, defines two states, namely PartialSum and PartialProd as shown in lines 5 and 6, respectively. It is observed that, inside the loop construct, for_each that begins in line 7, lines 8 and 9 can run concurrently to compute the partial_sum and partial_prod within an iteration. The final calculated values of partial_sum and partial_prod are returned from the function as a tuple in line 12. The loop construct can communicate to the function through the states/state variables associated with the loop construct as shown in lines 11 & 12.

Here two states defined in the loop construct partial_sum and partial_prod are used/mutated within the loop construct and hence clears the validation test for the first rule of State Variable Validation. The same code snippet in Example 2 becomes invalid if the statement update (partial_prod, partial_prod*input[i]) is not present in line 9, a Violation of State Variable Validation Rule occurs because no states defined in the loop construct are mutated within the loop construct.

The above example 2 holds equally well when two Collection Set State Variables are used instead of the Singleton State variables.

In a specific implementation, State Mutation Validation includes three types of mutations: State Update Mutation, State Append Mutation, and State Remove Mutation. Validation of the State Mutation rule is affected by the code structure of the loop construct. Subsequent explanations are carried out with State Update Mutation examples, but they hold for Append and Remove mutations, as well.

Provision of “Concurrency Enabled Loop Construct” through State Mutation Validation in different code structures listed below is dealt with as, for example, 1) Single loop construct, 2) Nested loop construct, 3) Single condition check construct within a loop construct, 4) Multiple condition check construct within a loop construct, and 5) Nested condition check construct within a loop construct. In the following examples, it is assumed behavioral aspects of the State variables are noted before formulating rules for State Validation Principles.

With Single Loop Construct Code Structure, the function has the main loop construct say, for_each, with its associated state variables. The state variables are mutated within the loop construct, and they are mutated not more than once in an iteration.

FIG. 3 is a flowchart 300 illustrating an example of Validating State Not Mutated More Than Once in an Iteration (Singleton and Collection Set States). The flowchart 300 starts at Singleton_and_CollectionSet_State_Mutation_Analyzer ( ) 302 and continues to decision point 304 where it is determined whether the number of Statements that mutate the Singleton State Variables (MSSV) within the Loop Construct are equal to the number of Singleton State Variables mutated within the Loop Construct (SSV_M). If not (304-No), then the flowchart 300 continues to module 306 where an error occurs, which can be characterized as generating an error message “Singleton State Mutated More than Once—State Mutation Validation Error” because Singleton States are mutated more than once; then the flowchart 300 ends at Return ( ) 308.

If, on the other hand, MSSV=SSV_M (304-Yes), then the flowchart 300 continues to decision point 310 where it is determined whether the number of statements that mutate the Collection Set State Variables within the Loop Construct (MCSetV) is equal to the number of Collection Set State Variables mutated within the Loop Construct (CSetV_M). If not (310-No), then the flowchart 300 continues to module 312 where an error occurs, which can be characterized as generating an error message “Collection Set State Mutated More than Once—State Mutation Validation Error” because Collection Set States are mutated more than once; then the flowchart 300 ends at Return ( ) 308.

If, on the other hand, MCSetV =CSetV_M (310-Yes), which means every Singleton State is Mutated only Once then flowchart continues to module 314 where an error does not occur, which can be characterized as generating a message “Singleton and Collection Set States not Mutated more than Once—State Mutation Validation Successful” because every Collection Set State is also Mutated only Once; then the flowchart 300 ends at Return ( ) 308.

Thus, the flowchart 300 illustrates how a Loop Concurrency Validator Engine, such as the Loop Concurrency Validator Engine 106 of FIGS. 1A and 1B, verifies if the number of mutation statements, here the “update” statements on the Singleton state variables, are equal to the number of Singleton State variables declared and if there are more number of statements, throws an error “SINGLETON STATE MUTATED MORE THAN ONCE—ERROR” and terminates, but if it clears this validation, the same is done for the Collection Set State variables to verify if the state is not mutated more than once and failing which it throws an error “COLLECTION SET STATE MUTATED MORE THAN ONCE—ERROR”. This may be carried out by semantic validation.

Consider the code snippet in Example 3. Here, the first State Validation rule defines that states defined with a loop construct are mutated within the loop construct, as was described with reference to FIG. 2, and now we proceed with the second State Mutation Validation rule of a State Variables. Here, a singleton state variable is allowed to be mutated not more than once within the loop construct. This may be carried out by semantic validation.

```
  1 StateConcurrency1:= Function
  2 parameter
  3 Input[ ]: number[ ]
  4 state
  5 PartialSum:= Number(init: 0)
  6 PartialProd:= Number(init:1)
  7 for_each(I, in: 1..input[ ].count)
  8 update(partial_sum, partial_sum + input[i])
  9 update(partial_prod, partial_prod * input[i])
10
11 return
12 (partial_sum, partial_prod)
```

### Example 3. Sample (Valid) Code Snippet for Concurrently Updating Multiple States Within a Loop Construct

In the sample code snippet of Example 3, a function named “StateConcurrency1” is defined with its parameter block accepting the input sequence Input[ ] as seen in lines 2 and 3. The state block that begins at line 4, defines two states namely PartialSum and PartialProd as shown in lines 5 and 6, respectively. It is observed that, inside the loop construct, for_each that begins in line 7, lines 8 and 9 are executed concurrently to compute the partial_sum and partial_prod within an iteration. The final computed values of partial_sum and partial_prod are returned from the function as a tuple in line 12. The loop construct can communicate to the function through the return statements in lines 11 & 12. Thus, states defined with the loop construct are mutated within the loop construct and they are mutated not more than once.

The same code snippet in Example 3 becomes invalid under the second rule of SVM principle if an update (partial_sum, partial_sum*input[i]) is added to line 10 which leads to violation of State Mutation Validation Rule for a Singleton State, because the same state partial_sum is mutated twice within the loop construct in lines 8 and 9.

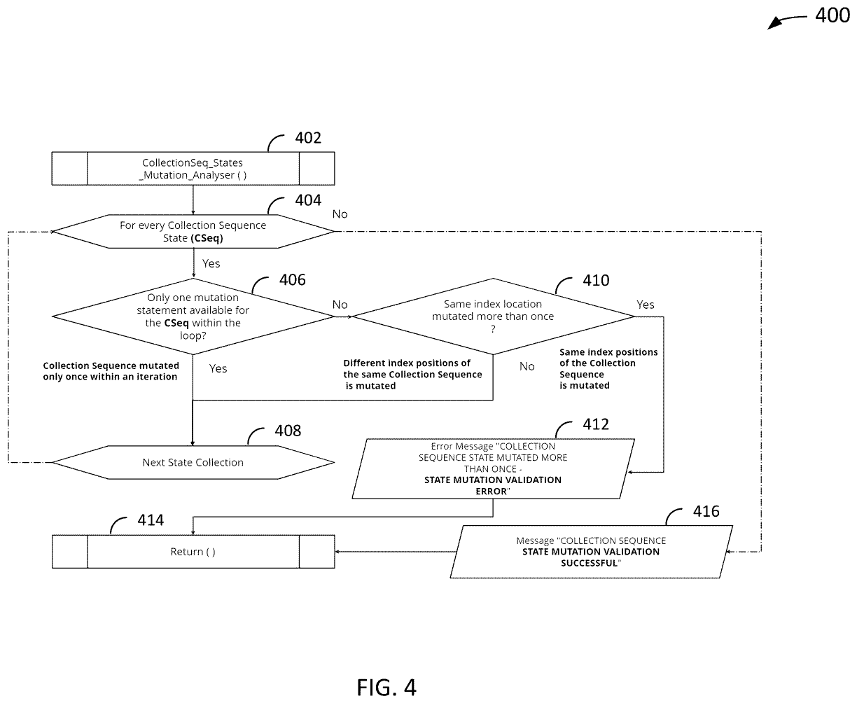

FIG. 4 is a flowchart illustrating an example of Validating State Not Mutated More Than Once in an Iteration (Collection Sequence States). The flowchart 400 starts at CollectionSeq_States_Mutation_Analyzer ( ) 402 and continues to module 404 where for every Collection Sequence State (CSeq), the flowchart 400 continues to decision point 406 where it is determined whether only one mutation statement is available for the CSeq within the Loop. If so (406-Yes), the flowchart 400 continues to module 408 to proceed to Next State Collection because Collection Sequence is mutated only once within an Iteration; the flowchart 400 returns to module 404.

If, on the other hand, it is determined that not only one mutation statement is available for the CSeq within the Loop (406-No), then the flowchart 400 continues to decision point 410 where it is determined whether a same index location is mutated more than once. If not (410-No), the flowchart 400 continues to module 408 as described previously because a different index position of the same Collection Sequence is mutated.

If, on the other hand, it is determined a same index location is not mutated more than once (410-Yes), then the flowchart 400 continues to module 412 where an error occurs, which can be characterized as generating an error message “Collection Sequence State Mutated More than Once—State Mutation Validation Error” because a same index position of the Collection Sequence is mutated; then the flowchart 400 ends at Return ( ) 414.

After every CSeq is considered (Module 404), the flowchart 400 continues to Module 416 where an error does not occur, which can be characterized as generating a message “Collection Sequence State Mutation Validation Successful;” then the flowchart 400 ends at Return ( ) 414.

Thus, the flowchart 400 illustrates how a Loop Concurrency Validator Engine, such as the Loop Concurrency Validator Engine 106 of FIGS. 1A and 1B, performs Collection Sequence State Mutation Validation within the loop construct. In this example, multiple updates to the same Collection Sequence State Variable is permitted, but the index locations of the elements updated within the same iteration of the loop construct are to be different. If the same index location is updated again, then it violates the second rule that no state variable is updated more than once within a single iteration of the loop construct.

Consider the following code snippet.

```
  1StateSeq1[ ]:= Function
  2 parameter
  3 Input[ ]: number[ ]
  4 state
  5 StateSeq[ ]:= number[ ](init: input[ ])
  6 for_each(Idx, in: [1..2])
  7 update(state_seq[idx], 10)
  8 update(state_seq[idx+3], 30)
  9 return
10 state_seq[ ]
```

### Example 4. Sample (Valid) Code Snippet for Concurrently Updating Collection Sequence State Within a Loop Construct

The code snippet in Example 4 defines a function as in line 1 and accepts the input through parameter block in lines 2 and 3. The state block that begins in line 4, defines a state collection “StateSeq[ ]” as in line 5. In the loop construct, for_each block as shown in line 6, there are two mutations done through the update command to the Collection Sequence state variable state_seq[ ] as shown in lines 7 and 8, but the updates are on different indices and hence executing these two lines concurrently within an iteration will not produce erroneous results. The results are written to the state_seq[ ] at the end of the iteration due to, a delayed write strategy that is adopted for our Concurrency Enabled Loop Concurrency. The final output is returned through the return block as shown in lines 9 and 10.

The same code snippet in Example 3 becomes invalid under the following cases.

Case 1: If the mutation statements in line 7 & 8 are replaced with the following update statements.

7 update(state_seq[idx], input[idx]+5)
8 update(state_seq[idx], input[idx]*2)

This will update the same index location [idx] of the Collection Sequence State more than once within a single iteration of the loop construct and hence becomes invalid by violating the second rule of SVM Principle, the State Mutation Validation rule for Collection Sequence State Variables.

Case 2: If the mutation statements in line 7 & 8 are replaced with the following update statements.

7 update(state_seq[idx+10], input[idx]+5)
8 update(state_seq[idx*2], input[idx]*2)

The compiler verifies if index location [idx+10] and index location [idx*2] of state_seq are equal. If they are equal then the compiler throws an error since it violates the second rule of SVM Principle, the State Mutation Validation rule for Collection Sequence State.

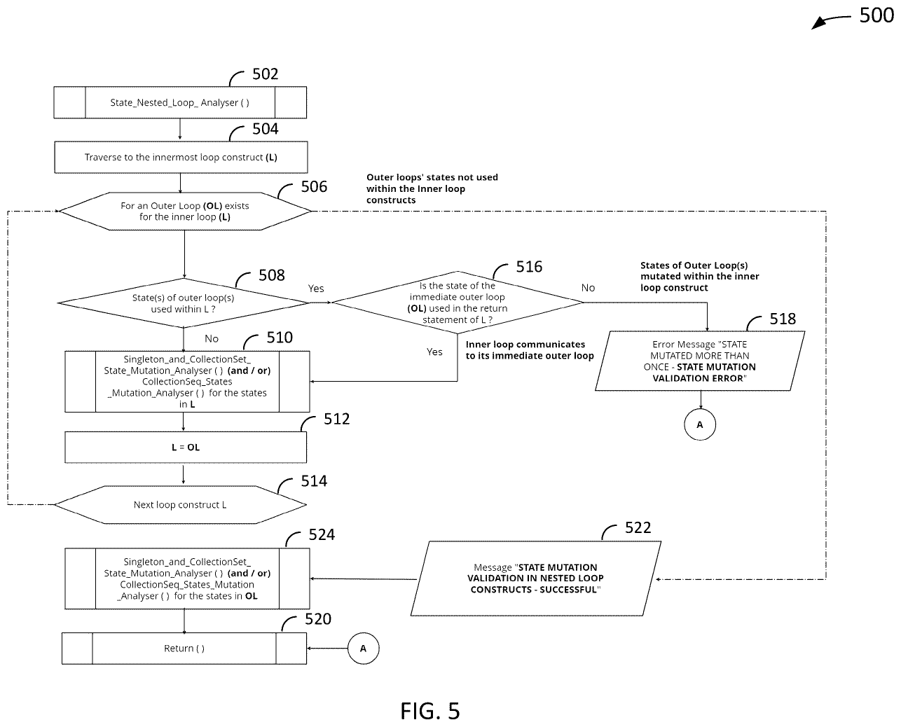

FIG. 5 is a flowchart illustrating an example of Validation of State Variable Mutation (SVM) Principle in Nested Loops. The flowchart 500 starts at State-Nested_Loop_Analyzer ( ) 502 and continues to module 504 where the innermost loop construct (L) is traversed and to module 506 where for an Outer Loop (OL) that exists for Inner Loop (L), the flowchart 500 continues to decision point 508 where it is determined whether a State of Outer Loop (OL) is used within Inner Loop (L). If not (508-No), the flowchart 500 continues to module 510 with Singleton_and_CollectionSet_State_Mutation_Analyzer ( ) and/or CollectionSeq_States_Mutation_Analyzer ( ) for the states in L, to module 512 with L =OL, and to module 514 where next loop construct L is considered, returning to module 506.

If, on the other hand, a State of OL is used within L (508-Yes), then the flowchart 500 continues to decision point 516 where it is determined whether state of the immediate outer loop (OL) is used in the return statement of L. If so (516-Yes), then the flowchart returns to module 510 because inner loop communicates to its immediate outer loop. If not (516-No), then the flowchart continues to module 518 where an error occurs, which can be characterized as generating an error message “State Mutated More than Once—State Mutation Validation Error” because a state of OL is mutated within L; then the flowchart 500 ends at Return ( ) 520.

After every Loop Construct (L) is considered (Module 506), the flowchart 500 continues to Module 522 where an error does not occur, which can be characterized as generating a message “State Mutation Validation in Nested Loop Construct Successful;” then the flowchart 500 continues to module 524 with Singleton_and_CollectionSet_State_Mutation_Analyzer ( ) and/or CollectionSeq_States_Mutation_Analyzer ( ) for the states in OL and ends at Return ( ) 520.

Thus, the flowchart 500 illustrates how a Loop Concurrency Validator Engine, such as the Loop Concurrency Validator Engine 106 of FIGS. 1A and 1B, verifies if the state variables of the outer loop are not used within the inner loop construct apart from the return statement. After completing this validation, the State Variables are subjected to State Variable Validation and State Mutation Validation depending on the type of the state variable in the loop construct.

State Variable validation and Collection State Mutation Validation in a code structure with nested loop constructs may need additional validations to realize loop concurrency without producing erroneous results. Private state variables of a loop construct can be used within the loop construct. In a nested loop construct, the outer loop construct's State variables cannot be mutated within the inner loop construct. This verification may be carried out by semantic validation. This verification is to prevent multiple updates of the outer loop's state variable; if permitted to mutate within the inner loop construct, which executes multiple times for each of the iterations of the outer loop, it will update the same state variable of the outer loop multiple times.

Consider the following code snippet.

```
  1 MatrixAccumulator1:= Function
  2 parameter
  3 Input[ ][ ]: number[ ][ ]
  4 state
  5 OuterAccum:= Number(init: 0)
  6 for_each(Inner[ ], in: input[ ][ ]) # Outer ForEach
  7 state
  8 InnerAccum:= Number(init: 0)
  9 for_each(Val, in: inner[ ]) # Inner ForEach
10 update(inner_accum, inner_accum + val)
11 return
12 update(outer_accum, outer_accum + inner_accum)
13 return
14 outer_accum
```

### Example 5. Sample (Valid) Code Snippet for Concurrently Updating Singleton States Within a Nested Loop Constructs

As shown in Example 5, a function named “MatrixAccumulator1” is defined as in line 1 to perform the summation of the elements of a two-dimensional sequence. The input is received in the parameter block in lines 2 and 3. The outer state block that begins in line 4, has the outer loop construct, for_each's state defined in line 5 and its for_each in line 6. The inner state block that begins in line 7, has its inner state as seen in line 8. The inner loop construct, for_each in line 9, performs an update in the inner Singleton state variable in line 10. To make modifications to the outer state depending on the inner state values, a return block is used as shown in lines 11 and 12.

In this return block, the outer state is modified according to the inner state's value. It will be executed after the inner for_each has completed the entire set of its iterations, where it can modify the outer state depending on the final value of the inner state (InnerAccum). The inner for_each takes care of performing the sum of the elements of a row. The computed inner_accum in line 10 is added with outer_accum in line 12 and returns the outer_accum value to outer for_each. This process of returning the accumulated sum from the inner loop construct, for_each to outer loop construct, for_each continues till the rows are exhausted in the input sequence. The final outer_accum that is returned by the function gives the sum of the elements of the matrix as seen in lines 13 and 14. Each of the for_each loop has a return statement through which the values of the state variables are communicated outside the loop. However, the outermost for loop uses the return statement of the function for this purpose.

Now, consider the following code snippet.

```
  1 MatrixAccumulator2:= Function
  2 parameter
  3 Input[ ][ ]: number[ ][ ]
  4 state
  5 Accum:= Number(init: 0)
  6 for_each(Inner[ ], in: input[ ][ ]) # Outer ForEach
  7 state
  8 Temp:= Number (init: 0)
  9 for_each(Val, in: inner[ ]) # Inner ForEach
10 update(accum, accum + val)
11 return
12 accum
```

### Example 6. Sample (Invalid) Code Snippet for Concurrently Updating Singleton States Within a Nested Loop Constructs

The code in Example 6 defines a function named “MatrixAccumulator2” as seen in line 1 to show the invalid case of State Validation in nested loop constructs. Here the parameter block that begins in line 2, accepts the input sequence in line 3. The state block that begins in line 4, declares a Singleton state variable named “Accum” and initializes it to zero as shown in line 5. The nested loop construct, for_each is seen in lines 7 and 10 within which, as shown in line 10, the Singleton state variable is updated. This update happens multiple times in the scope of outer loop construct, for_each, for each of the inner loop constructs, for_each. This violates the second rule of State Validation for Singleton states, and the compiler reports the error as STATE VALIDATION IN NESTED LOOP MUTATION-ERROR. The explanation for code snippets in example 4 & 5, is equally applicable to the Collection Set State variable also.

Now consider Collection Sequence State Variables updated within nested loop constructs as shown in the code snippet of Example 7.

```
  1StateSeqFun[ ]:= Function
  2 Parameter
  3 Input[ ]: Number[ ]
  4 State
  5 StateSeq1[ ]:= Number[ ](init: [ ])
  6 for_each(Idt, in: [1..2])
  7 State
  8 StateSeq2[ ]:= Number[ ](init: input[ ])
  9 for_each(Idx, in:[1..2])
10 update(state_seq2[idx], (input[idx] + 5) *2)
11 Return
12 update(state_seq1[idt], state_seq2[idt])
13 return
14 state_seq1[ ]
```

### Example 7. Code snippet for Collection Sequence State Mutated Within a Nested Loop Construct

Here, the Collection Sequence State Variable StateSeq1[ ] is associated with the outer loop construct and the Sequence State Variable StateSeq2[ ] is associated with the inner loop construct. Here, two sets of validations are to be made by the compiler. Hence, the compiler makes additional checks to validate the Collection Sequence State variables. The validation rules are 1) Usage of State Variables of the outer loop construct within the inner loops construct and 2) State Validation and State Mutation Validation within individual loop constructs.

The outermost loop construct's State Variable StateSeq1[ ] is not updated within the inner loop construct in lines 9 to 11. The return statement of the inner loop construct is the one which communicates to the outer loop construct. Hence, State Variable update in nested loop structure is validated. Now, the Sequence states StateSeq1[ ] and StateSeq2[ ] are used within the respective loop constructs and are not updated more than once within their respective loop constructs. This ensures that the State Variable Validation and State Mutation Validation of the Collection Sequence state variables in the above code snippet.

The above code snippet can become invalid if: 1) Accessing the state variable of the outer loop construct StateSeq1[ ] within the inner loop construct in lines 9 to 11.—Violating State Validation in nested loop constructs; or 2) Accessing the same index locations of the same Collection Sequence state variables within the loop constructs.

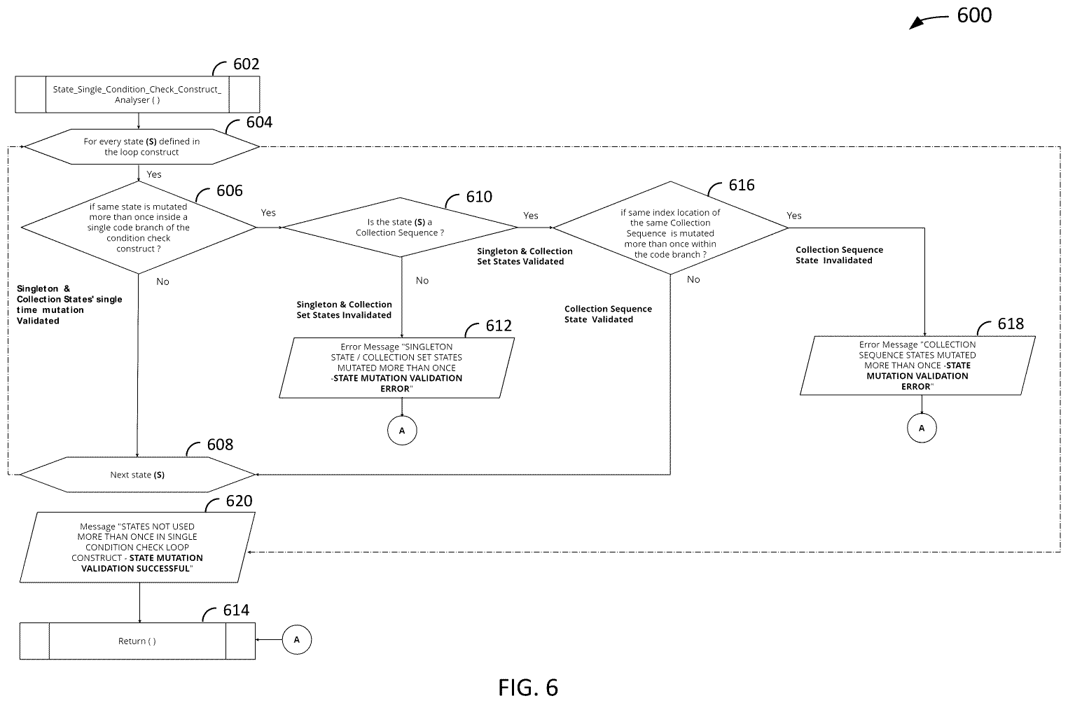

FIG. 6 is a flowchart 600 illustrating an example of Singleton and Collection State Mutation Validation in a Single Condition Check Construct within a Loop. The flowchart 600 starts at State_Single_Condition_Check_Construct_Analyzer ( ) 602 and continues to module 604 where for every State(S) defined in the loop construct, the flowchart 600 continues to decision point 606 where it is determined whether a same state is mutated more than once inside a single code branch of the condition check construct. If not (606-No), the flowchart 600 continues to module 608 to proceed to Next State(S) because Singleton and Collection States' single time mutation has been Validated; the flowchart 600 returns to module 604.

If, on the other hand, it is determined the same state is not mutated more than once inside a single code branch of the condition check construct (606-Yes), then flowchart 600 continues to decision point 610 where it is determined whether State(S) is a Collection Sequence. If not (610-No), the flowchart 600 continues to module 612 where an error occurs, which can be characterized as generating an error message “Singleton State/Collection Set States Mutated More than Once—State Mutation Validation Error” because Singleton and Collection Set States are Invalidated; then the flowchart 600 ends at Return ( ) 614.

If, on the other hand, it is determined State(S) is not a Collection Sequence (610-Yes), the flowchart 600 continues to decision point 616 where it is determined whether same index location of same Collection Sequence is mutated more than once within the code branch. If not (616-No), the flowchart 600 continues to module 608 to consider next state(S) because Collection Sequence State is Validated. If so (616-Yes), the flowchart 600 continues to module 618 where an error occurs, which can be characterized as generating an error message “Collection Sequence States Mutated More than Once—State Mutation Validation Error” because Collection Sequence State is Invalidated; then the flowchart 600 ends at Return ( ) 614.

After every State(S) is considered (Module 608), the flowchart 600 continues to Module 620 where an error does not occur, which can be characterized as generating a message “States Not Used More than Once in a Single Condition Check Loop Construct—State Mutation Validation Successful;” then the flowchart 600 ends at Return ( ) 614. In this example, the use of state variables across the code branches in the condition check construct is assumed to be validated before passing on for State Mutation Validation.

Thus, the flowchart 600 illustrates how a Loop Concurrency Validator Engine, such as the Loop Concurrency Validator Engine 106 of FIGS. 1A and 1B, performs State Mutation Validation for Singleton and Collection State Variables (both sets and sequences). The states being mutated more than once are verified within each of the code branches. This flowchart throws an error when a singleton or collection set state is mutated more than once within a single code branch with an additional check for the Collection Sequence variables where the same index mutation is not permitted within the same code branch.

Loop constructs with single condition check construct (single if_else, nested if_else, switch) may need to be handled more specifically pertaining to each of the condition check branches. The State Variable Validation and State Mutation Validation rules are defined as follows to facilitate loop concurrency: 1) The State Variables are used across the code branches in the condition check construct and validated for No Unused State Variables; 2) the Same State Variable is not mutated more than once in a single code branch for a Singleton State Variable and a Collection Set State Variable, but for a Collection Sequence State Variable, the same index locations should not be mutated more than once in a single code branch. The two constraints may be carried out by semantic validation.

Consider the following code snippet.

```
  1FamilySpecialCreditAllocator:= Function
  2 Parameter
  3 Family
  4 State
  5 Special := Number(init: 1000)
  6 FinancialDependency? := boolean (init: ‘False’)
  7 for_each(P, in: family.member{ })
  8 if(p.age <= 20 & p.income > 5000)
  9 update(financial_dependency, “INDEPENDENT”)
10 else_if(p.age >= 60 & p.income>15000)
11 update(financial_dependency, “INDEPENDENT”)
12 else_if (p.income<10000)
13 update(financial_dependency, “DEPENDENT”)
14 update(special, special + 5000)
15 else
16 update(financial_dependency, “INDEPENDENT”)
17 Return
18 (special, financial_dependency)
```

### Example 8. Code Snippet for a Single Condition Check Construct Within a Loop Construct

Here, two Singleton state variables Special and FinancialDependency are associated with the loop construct. In lines 7 to 17, there are three code branches in lines 8, 11, 13 and 16. It could be observed that both the Singleton state variables are used in each of the code branches, but, across the code branches, both the Singleton State Variables are mutated. Moreover, the same Singleton state variable is not mutated more than once in any of the code branches, here, the “if” code branch in line 8 or “else_if” code branch in line 11 or “else_if” code branch in line 13 or the “else” in line 16. Thus, this code clears the validation for SVM principles. The code snippet and its explanation hold equally well for Collection Set State variables.

The above code snippet would become invalid if either 1) The Singleton State variable FinanciallyDependent is not used anywhere in the code snippet—Violating states defined with the loop construct are to be used condition; or 2) if line numbers 8, 9 and 10 have the following code, thereby violating a single state mutated not more than once condition:

```
  8 if(p.age<=20 & p.income > 5000)
  9 update(special, special+1000)
10 update(special, special*2)
```

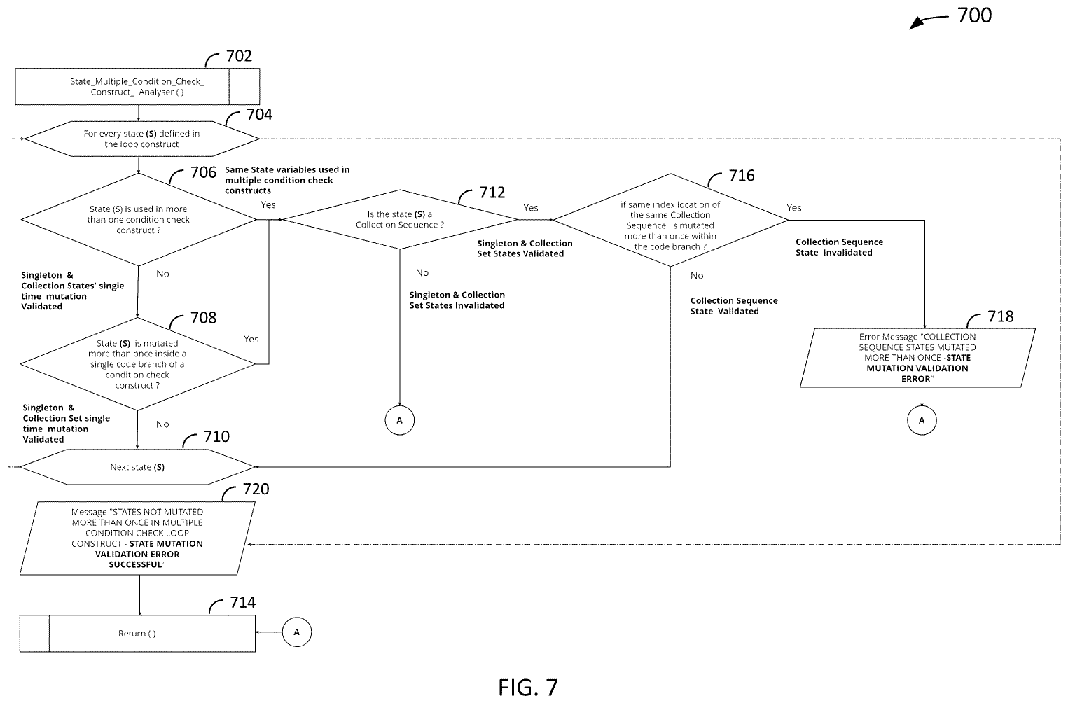

FIG. 7 is a flowchart 700 illustrating an example of Singleton and Collection States Mutation in Multiple Condition Check Constructs within a Loop. The flowchart 700 starts at State_Multiple_Condition_Check_Construct_Analyzer ( ) 702 and continues to module 704 where for every State(S) defined in the loop construct, the flowchart 700 continues to decision point 706 where it is determined whether State(S) is used in more than one condition check construct. If not (706-No), the flowchart 700 (because Singleton and Collection States' single time mutation has been validated) continues to decision point 708 where it is determined whether State(S) is mutated more than once inside a single code branch of a condition check construct. If not (708-No), the flowchart 700 continues to module 710 to proceed to Next State(S) because Singleton and Collection Set single time mutation has been Validated; the flowchart 700 returns to module 706.

If, on the other hand, it is determined State(S) is used in more than one condition check construct (706-Yes), the flowchart 700 continues to decision point 712 where it is determined whether State(S) is a Collection Sequence. If not (712-No), the flowchart 700 ends at Return ( ) 714 because Singleton and Collection Set States are Invalidated (and an appropriate Error can be generated). Similarly, if it is determined State(S) is used in more than once condition check construct (706-Yes), the flowchart 700 continues to decision point 712 as just described because Same State variables are used in multiple condition check constructs.

If, on the other hand, it is determined State(S) is a Collection Sequence (712-Yes), the flowchart 700 continues to decision point 716 where it is determined whether same index location of same Collection Sequence is mutated more than once within the code branch. If not (716-No), a next state(S) is considered at module 710 because Collection Sequence State is Validated. If so (716-Yes), the flowchart 700 continues to module 718 where an error occurs, which can be characterized as generating an error message “Collection Sequence States Mutated More than Once—State Mutation Validation Error” because Collection Sequence State is Invalidated; then the flowchart 700 ends at Return ( ) 714.

After every State(S) is considered (Module 704), the flowchart 700 continues to Module 720 where an error does not occur, which can be characterized as generating a message “States Not Mutated More than Once in a Multiple Condition Check Loop Construct—State Mutation Validation Successful;” then the flowchart 700 ends at Return ( ) 714. In this example, State Variable validation to check the variables being used within the loop construct across the condition check constructs is validated before subjecting the code to State Mutation Validation.

Thus, the flowchart 700 illustrates how a Loop Concurrency Validator Engine, such as the Loop Concurrency Validator Engine 106 of FIGS. 1A and 1B, performs State Mutation Validation for three types of State variables. No state mutated more than once within a code branch is validated within each of the code branches. Collection Sequence State variables are specifically checked for not updating the same index location more than once. This process throws an error when any of the states remain unused or when a single state is mutated more than once in a code branch.

State variable validation when the loop construct accommodates multiple condition check constructs is also handled effectively using the State Validation Principles to facilitate Concurrency Enabled Loop Construct. Consider the following code snippet.

```
  1 AllowanceCalculator:= Function
  2 parameter
  3 Family
  4 state
  5 Special:= number(init: 1000)
  6
  7 for_each(P, in: family.member{ })
  8 if (p.age <= 18)
  9 update(special, special + 500)
10 else_if (p.age >= 60)
11 update(special, special + 1000)
12 else
13 update(special, special + 800)
14 if(p.income<50000)
15 update(special, special + 1500)
16 return
17 (standard, special)
18 _Standard: family.member{ }.count * 1000
```

### Example 9. An Invalid Code Snippet for State Mutation in Loop Construct With Multiple Condition Check Constructs

In the above Example 9, lines 14 & 15 have an additional condition check construct (if_else) which updates the same singleton state “special”. This is a violation of the state mutation rule, where the same state will be mutated once in the first condition check construct in lines 7 to 12 and again in lines 14 & 15. Hence, the compiler throws an error message.

A valid scenario of state mutation under multiple condition check constructs is the one where there is an additional singleton state Category defined with the for-loop construct, and lines 4-6, 14 and 15 are as follows.

```
  4 state
  5 Special := number(init: 1000)
  6 Category := String
  .
  .
14 if(p.age<18)
15 update(category, “Minor”)
```

This state variable “category” is communicated to the function using the return statement, which can return multiple values as a tuple.

The above example can also be explained with a state collection being mutated in the loop construct. Here, if the same index locations are mutated in different condition check constructs, then the compiler invalidates the code and throws an error. However, if different index locations of the state collections are mutated in different condition check constructs, it is a valid mutation permitted by the compiler. The above conditions may be carried out by semantic validation.

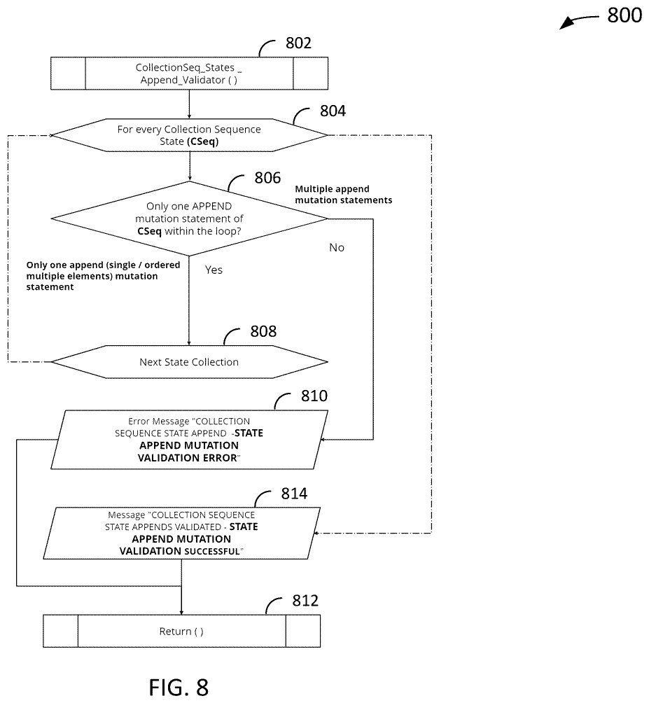

FIG. 8 is a flowchart 800 illustrating an example of Collection Sequence State Append Operation Validation. The flowchart 800 starts at CollectionSeq_States_Append_Validator ( ) 802 and continues to module 804 where for every Collection Sequence (CSeq) State, the flowchart 800 continues to decision point 806 where it is determined whether there is only one Append mutation statement of CSeq within the loop. If so (806-Yes), the flowchart 800 continues to module 808 to proceed to Next State Collection because there is only one append (single/ordered multiple elements) mutation statement; the flowchart 800 returns to module 804. If not (806-No), the flowchart 800 continues to module 810 where an error occurs, which can be characterized as generating an error message “Collection Sequence State Append—State Append Mutation Validation Error” because there are multiple Append mutation statements; then the flowchart 800 ends at Return ( ) 812.

After State Collection is complete (Module 804), the flowchart 800 continues to Module 814 where an error does not occur, which can be characterized as generating a message “Collection Sequence State Appends Validated—State Append Operation Mutation Validation Successful;” then the flowchart 800 ends at Return ( ) 812.

Thus, the flowchart 800 illustrates how a Loop Concurrency Validator Engine, such as the Loop Concurrency Validator Engine 106 of FIGS. 1A and 1B, performs checks for each of the Collection Sequence State variables if there is not more than one associated “Append” mutation statement within the loop construct. That “Append” can either be appending a single element or an ordered collection of more than one element. But if there are more than one “Append” statements for the same Collection Sequence State variable, then the compiler throws an error “COLLECTION SEQUENCE STATE APPEND OPERATION—STATE MUTATION VALIDATION ERROR”. This validation is applicable to the Collection Sequence State Variable and the Collection Set State Variable can have multiple append statements and/or single append statements with an ordered set of elements.

State Variable validation for a nested condition check construct within a loop is treated similar to multiple condition check constructs where the outermost condition check constructs in the nested structure are treated as single condition check constructs and processed as a Multiple Condition Check Construct within a Loop Construct.

Consider the following pseudocode.

```
  1Sample:= Function
  2 Parameter
  3 Input[ ]: number[ ]
  4 State
  5 S1
  6 S2
  7 S3
  8 S4
  9 for_each(I, in: input[ ])
10 if(cnd1) ## changes “s1”, “s2”, “s3”; no other line in the for_each outside this entire if-else
ladder can modify these states
11 if(cnd2) ## changes “s1”, “s2”
12 update(s1, ...)
13 update(s2, ...)
14 else_if(cnd3) ## changes “s1”, “s3”
15 update(s1, ...)
16 update(s3, ...)
17 else ## changes “s2”
18 update(s2, ...)
19 else ## changes “s1”, “s3”
20 if(cnd4) ## changes “s1”
21 update(s1, ...)
22 else ## changes “s3”
23 update(s3, ...)
24 if(cnd5) ## changes “s4”; no other line in the for_each outside this entire if-else ladder can
modify s4
25 update(s4, ...)
```

### Example 10. Pseudocode for Singleton and Collection Set State Mutation Validation in Nested Condition Check Constructs Within a Loop Construct

In example 10, the outer condition check constructs in lines 11, 19, and 24 are treated as multiple condition check constructs and validate the use of the state variables within the outermost condition check construct. Here, states s1, s2, s3, and s4 are Singleton states or Collection Set States. State Variables s1, s2, and s3 are used within the outer condition check construct in lines 11 to 23. The state variables s4 can be used inside the outer loop construct in lines 24 and 25. If Collection Sequence State Variables are used, then the individual index locations are treated as distinct states and the validations are done to handle them as in the earlier cases. The above conditions may be carried out by semantic validation.

Apart from the “Update” mutation, there are two other mutations, “Append” and “Remove” that operate on Collection Sequence State Variables.

Appending to a sequence is treated as modifying its last index. Since Concurrency Enabled Loop Construct follows delayed write, where the write operation happens at the end of the iteration, there will be a race condition if multiple append statements are used within a single iteration in a loop. Consider the following code snippet.

```
  1 StateSeqAppend2:= Function
  2 parameter
  3 Input[ ]:number[ ]
  4 state
  5 StateSeq[ ]:= Number[ ](init: [ ])
  6 for_each(_, in: [1..2])
  7 state_seq[ ].append([100])
  8 state_seq[ ].append([200])
  9 return
10 state_seq[ ]
```

### Example 11. Sequence-Append-Second

The sample code in Example 11, begins with a function definition as in line 1. The input is received in the parameter block as seen in lines 2 and 3. The state block begins in line 4 to define the state sequence variable in line 5. The for_each block that begins in line 6, performs two appends within the same iteration as shown in lines 7 and 8. At the end of an iteration, statements 7 & 8 try to modify the last index of the state_seq[ ] variable which will result in unexpected results storing the last value written in the delayed write. So, such multiple appends are not permitted in order to preserve Loop Concurrency. The compiler throws an error as “COLLECTION SEQUENCE STATE APPEND OPERATION ERROR”.

However, multiple appends are made possible using a single append statement with an ordered set of values to be appended. This is shown in the following code snippet.

1 StateSeqAppend1:= Function
2 parameter
3 Input[ ]:number[ ]
4 state
5 StateSeq[ ]:= Number[ ](init: [ ])
6 for_each(_, in: [1..2])
7 state_seq[ ].append([100,200])
8 return
9 state_seq[ ]

### Example 12. Sequence-Append-First

The sample code in Example 12, defines a function as seen in line 1 and accepts the input through the parameter block as shown in lines 2 and 3. The state block that begins in line 4, defines a state sequence variable as seen in line 5. In line 6, the for_each block begins, which performs an append as shown in line 7. The append operation in line 7, appends the numbers 100 and 200 at the end of the state sequence index position in the same order as clubbed. An append operation is accessed through a state sequence variable using a “.” operator and takes its general form as “append([val1, val2])”. This reveals that if a state sequence is appended with two different values like val1 and val2 by using ordered/clubbed append, the operation is considered to be valid. The appended state sequence variable is returned as output of the function as shown in lines 8 and 9. The State_Sequence_Append Validation checks if, “Multiple appends on a sequence are ordered/clubbed together”.

Removing elements from a Collection Sequence are based on value or index. Remove operations are delayed to the end of the iteration, and the elements are removed as a single operation. This permits the remove statements to be given as a single statement with an ordered set of elements/index positions to be removed from the Collection Sequence Variable.

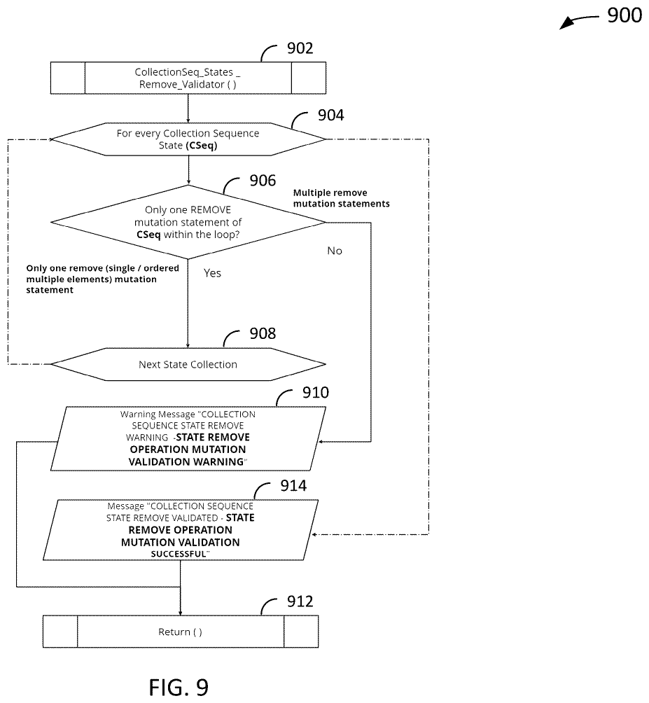

FIG. 9 is a flowchart illustrating an example of Collection Sequence State Remove Operation Validation. The flowchart 900 starts at CollectionSeq_States_Remove_Validator( ) 902 and continues to module 904 where for every Collection Sequence (CSeq) State, the flowchart 900 continues to decision point 906 where it is determined whether there is only one Remove mutation statement of CSeq within the loop. If so (906-Yes), the flowchart 900 continues to module 908 to proceed to Next State Collection because there is only one remove (single/ordered multiple elements) mutation statement; the flowchart 900 returns to module 904. If not (906-No), the flowchart 900 continues to module 910 where an error occurs, which can be characterized as generating an error message “Collection Sequence State Remove Warning—State Remove Mutation Validation Warning” because there are multiple Remove mutation statements; then the flowchart 900 ends at Return ( ) 912.

After State Collection is complete (Module 904), the flowchart 900 continues to Module 914 where an error does not occur, which can be characterized as generating a message “Collection Sequence State Remove Validated—State Remove Operation Mutation Validation Successful;” then the flowchart 900 ends at Return ( ) 912.

Thus, the flowchart 900 illustrates how a Loop Concurrency Validator Engine, such as the Loop Concurrency Validator Engine 106 of FIGS. 1A and 1B, performs validation of remove statements within a loop construct where multiple remove statements are invalidated and a single remove with a single or multiple ordered elements are permitted. During compilation, multiple remove statements trigger a warning message. However, internally, the statements are combined as an ordered set of elements in the code optimization phase and made available for removal as a single mutation on the collection sequence during runtime. In a specific implementation, multiple removes on a sequence are performed as a single cumulative modification.

Consider the code snippet where multiple removes are mentioned as multiple statements in the code.

```
  1 StateSeqRemove1:= Function
  2 parameter
  3 Input[ ]:number[ ]
  4 state
  5 StateSeq[ ]:= Number[ ](init: [ ])
  6 for_each(_, in: [1..2])
  7 state_seq[ ].remove(element: 500)
  8 state_seq[ ].remove(element: 30)
  9 return
10 state_seq[ ]
```

### Example 13. Code Snippet With Multiple Remove Element Statements for a Collection Sequence State Variable

The sample code in Example 13, defines a function as shown in line 1, with the parameter block that accepts the input as in lines 2 and 3. The state block that begins in line 4, defines a state sequence variable as seen in line 5. The for_each block that begins in line 6, allows two elements of the state sequence to be removed as shown in lines 7 and 8 within the same iteration. The remove operation is also accessed through a state sequence variable using a “.” operator and takes its general form as “remove (element: value)”, where the element with its specified value is searched in the sequence and then removed. The return block that begins in line 9 returns the Collection Sequence state variable as the output of the function as in line 10. However, the above code snippet will throw a warning message during compilation stating “COLLECTION SEQUENCE STATE REMOVE WARNING—STATE REMOVE OPERATION MUTATION VALIDATION WARNING. If the multiple remove operation as seen in lines 7 and 8 are replaced as state_seq[ ].remove (element:[500,30]) by the compiler during the code optimization and the elements of the sequence are removed as a single mutation by the compiler and is executed.

```
  1 StateSeqRemove2:= Function
  2 parameter
  3 Input[ ]:number[ ]
  4 state
  5 StateSeq[ ]:= Number[ ](init: [ ])
  6 for_each(_, in: [1..2])
  7 state_seq[ ].remove(index: 5)
  8 state_seq[ ].remove(index: 3)
  9 return
10 state_seq[ ]
```

### Example 14. Code Snippet With Multiple Remove Index Statements for a Collection Sequence State Variable

The sample code in Example 14, begins with the function definition (line 1) that accepts the input through the parameter block as seen in lines 2 and 3. The state block that begins in line 4 defines a state sequence variable in line 5. The for_each block that begins in line 6, performs two remove operation based on the index locations of the state sequence variable as seen in lines 7 and 8. The updated state_seq[ ] as in lines 9-10 is returned finally as output. The multiple remove operation as seen in lines 7 and 8 violate the second rule of SVM principle and hence throws and warning during compilation but are replaced as state_seq[ ].remove (index:[5,3]) in the code optimization phase of the compilation to get this code validated, where the index of the sequence elements to be removed as a single operation.

A use case scenario is now described. An organization celebrates its Silver jubilee and is offering gifts to its employees based on the following criteria: 1) Each employee is given two gifts (CoinGift and CashGift). 2) If the employee has served more than 10 years in the organization, the employee is given a gold coin, and other employees are given a silver coin. 3) A cash gift of 5% of the employee's salary is given, but if the employee opts to get this amount as cash, then an amount tax_slab*cash_gift is deducted from the cash_gift and the balance is credited to the employee's bank account (where tax_slab is the taxation slab under which the employee is categorized based on the employee's annual salary); however, if the employee opts for a gift voucher, then the total cash gift amount is credited as a gift voucher to the employee.

```
  1 #Employee Gift Allocation Module
  2 Organization:= new type
  3 Employee[ ]
  4
  5 Organization/Employee:= new type
  6 Salary:= new number #basic pay
  7 OptCash?:= new Boolean
  8 Exp:= new number
  9 TaxSlab:=new number
10
11 EmployeeGift: (CoinGift[ ]: string[ ], VoucherAmount[ ]: number[ ], InHandAmount[ ]:
number[ ])
12
13 GiftAmount[ ]:= new function
14 Parameter
15 Emp[ ]: employee[ ]
16 State
17 CoinGift[ ]:= new string[ ](default: [ ])
18 VoucherAmount[ ]:= (id,number)
19 InHandAmount[ ]:= (id,number)
20 for_each(E, in: emp[ ])
21 #coin gift
22 if(e.exp > 10)
23 append(coin_gift[ ], “gold”)
24 Else
25 append(coin_gift[ ], “silver”)
26
27 #cash_gift
28 if(e.opt_cash?)
29
30 append(in_hand_amount[ ], (E.id,(0.05 * e.salary) − (tax_slab * (0.05 * e.salary))))
31 Else
32 append(voucher_amount[ ], (E.id,0.05 * e.salary))
33
34 return ‘EmployeeGift’(coin_gift[ ]: coin_gift[ ], voucher_amount[ ]: voucher_amount[ ],
in_hand_amount[ ]: in_hand_amount[ ])
```

### Example 15. Code Snippet for Gift Calculator

In the above example 15, three state sequences CoinGift, VoucherAmount and InHandAmount are defined to be used in the for loop in line 20. Coin gift assignment is done in line numbers 22 to 25 and cash gift assignment is done in line numbers 28 to 33. The two gift assignments run concurrently. In the Coin gift assignment if_else statement, the state sequence coin_gift is updated either in the if condition or in the else condition and hence it is a valid update statement. Similarly, in the cash gift assignment if_else statement, the state sequences voucher_amount and in_hand_amount are updated either in the if condition or in the else part and hence are valid update statements. When the if condition is satisfied, update statements 29 and 30 run concurrently, and when it fails, update statements 32 and 33 run concurrently.

The for-loop concurrency enables the state sequences to be updated concurrently in both the if_else conditions. Moreover, each of the state sequences is updated once and not more than once within the for loop, and this is ensured by the compiler by using the following condition checking in the for loop.

Unused State Validation is done using the condition check: Number of States modified within the loop=Number of States defined with the loop. State Used Not More Than Once validation is done using the condition check: Number of State Modifications done within the loop=Number of States Modified within the loop. The compiler checks the conditions to verify the state variable update check within the for loop.

What is claimed is:

1. A method comprising:
receiving source code at a compiler;
verifying a State Variable Mutation (SVM) principle in the compiler for a loop construct that includes one or more state variables defined in association with the loop construct identified from the source code, wherein the SVM principle is unsatisfied when total defined state variables is unequal to total unique states mutated within the loop construct;
generating a compiler error when the SVM principle is unsatisfied during compilation;
providing validated executable code when compilation by the compiler is successful.

2. The method of claim 1 comprising providing values of the mutated state variables at the end of the loop construct if the SVM principle is satisfied.

3. The method of claim 1, wherein the state variables are accessed within the scope of the loop construct.

4. The method of claim 1, wherein a loop concurrency validator prevents mutation of a variable defined outside the scope of the loop construct within the loop construct.

5. The method of claim 1, wherein instructions of an indentation within the loop construct are executed concurrently.

6. The method of claim 1, wherein each state variable of the one or more state variables is a singleton variable or a collection variable.

7. The method of claim 1, wherein a collection variable of the one or more state variables includes an unordered set of non-duplicate elements or a sequence of ordered elements.

8. The method of claim 1, wherein a modification operation changes a value of a first state variable of the one or more state variables, and wherein the modification operation is an update operation.

9. The method of claim 1, wherein a modification operation changes a value of a singleton state variable of the one or more state variables relative to a previous iteration of the singleton state variable.

10. The method of claim 1, wherein a modification operation modifies at least one element of a collection set state variable of the one or more state variables relative to a previous iteration of the collection set state variable element.

11. The method of claim 1, wherein a modification operation modifies at least one indexed element of a collection sequence state variable of the one or more state variables relative a previous iteration of the collection sequence state variable indexed element.

12. The method of claim 1, wherein a modification operation changes size of a collection set state variable of the one or more state variables and wherein the modification operation is selected from a group of operations consisting of update, remove, and append.

13. The method of claim 11, wherein the collection set state variable size is increased by one or more elements relative to a previous iteration of the state variable.

14. The method of claim 11, wherein the collection set state variable size is decreased by one or more elements relative to a previous iteration of the state variable.

15. The method of claim 11, wherein the collection set state variable is a collection sequence state variable, and the collection set state variable size is increased by one or more elements relative to a previous iteration of the collection sequence state variable.

16. The method of claim 11, wherein the collection set state variable is a collection sequence state variable, and the collection set state variable size is decreased by one or more elements relative to a previous iteration of the collection sequence state variable.

17. The method of claim 1, wherein verifying the SVM principle includes comparing a total number of state variables within the loop construct to a total number of unique states modified within the loop construct.

18. The method of claim 1, wherein verifying the SVM principle includes comparing a total number of state variables within the loop construct to a total number of mutation statements in the loop construct.

19. The method of claim 1, wherein more than one mutation statement on a singleton state variable of the one or more state variables generates an invalid mutation error.

20. The method of claim 1, wherein more than one mutation statement on a collection set state variable of the one or more state variables generates an invalid mutation error.

21. The method of claim 1, wherein two or more mutation statements on a collection sequence state variable of the one or more state variables generates an invalid mutation error when more than one of the statements updates the same index location.

22. The method of claim 1, wherein two or more mutation statements on a collection sequence state variable of the one or more state variables do not generate an invalid mutation error when no two mutation statements access the same index location.

23. The method of claim 1, wherein the one or more state variables are returned to an immediate outer scope of the loop construct using a return statement.

24. The method of claim 22, wherein the loop construct is available directly within a function and uses a return statement of the function.

25. The method of claim 22, wherein an inner loop construct of the loop construct uses an additional return statement to return the state variables.

26. The method of claim 1, wherein the loop construct is a for_each loop construct, and wherein mutation of an iteration parameter of the for_each loop construct is prohibited within the loop construct.

27. The method of claim 1, wherein the SVM principle is unsatisfied when a state variable of the defined state variables is mutated more than once within the loop construct.

28. A system for compiling source code, comprising:
a scanner and parser engine that scans and parses a source code statement, wherein the source code statement defines one or more state variables and a loop construct in which the one or more state variables are mutated;
an intermediate representation generator engine that receives a parse tree from the scanner and parser and generates an Intermediate Representation (IR);
a loop concurrency validator engine that receives the IR and generates a concurrency validated IR;
a code optimizer engine that receives the concurrency validated IR and generates an optimized concurrency validated IR;
a code generator engine that receives the optimized concurrency validated IR and generates executable code.

29. The system of claim of 28, wherein the loop concurrency validator engine includes:
a state validator subengine to perform validation of the one or more state variables in the IR, which are mutated within the loop construct, and to generate an error if not validated;
a state dependency analyzer subengine to associate the one or more state variables to corresponding loop constructs, wherein the one or more state variables of the loop construct are valid as determined by the state validator subengine;
a state mutation analyzer subengine that includes a state localizer and an instruction-specific state appropriator, wherein during operation the state mutation analyzer determines that a first state variable of the one or more state variables is a single state variable, the state localizer determines a scope of the first variable with respect to the loop construct, and the instruction-specific state appropriator determines that a state of the loop construct within a determined scope is assigned to not more than one mutation instruction.

30. The system of claim 28, wherein the state mutation analyzer subengine includes a state localizer and an instruction-specific state appropriator, wherein during operation the state mutation analyzer determines that a first state variable of the one or more state variables is a collection sequence state variable with a collection sequence, the state localizer determines a scope of the first variable with respect to the loop construct, and the instruction-specific state appropriator determines that the same index location of the collection sequence is assigned to not more than one mutation instruction.
